(19) United States
(12) Patent Application Publication
(10) Pub. No.: US 2024/0169341 A1
(43) Pub. Date: May 23, 2024

(54) KEY IN VEHICLE ASSURANCE SERVICE

(71) Applicants: DENSO International America, Inc., Southfield, MI (US); DENSO CORPORATION, Kariya-city (JP)

(72) Inventors: Matthew JOHNSON, Oak Park, MI (US); Martín NESPOLO, Grosse Pointe Woods, MI (US); Thomas KRZYZAK, Livonia, MI (US); Sibu VARUGHESE, Shelby Township, MI (US); Wilson YIM, Ann Arbor, MI (US); Ginelle Margaret Reed, Novi, MI (US)

(73) Assignees: DENSO International America, Inc., Southfield, MI (US); DENSO CORPORATION, Kariya-city (JP)

(21) Appl. No.: 17/991,446

(22) Filed: Nov. 21, 2022

(51) Int. Cl. G06Q 20/32; G06Q 30/0645

(52) U.S. Cl. CPC G06Q 20/3224; G06Q 30/0645

(57) ABSTRACT

A vehicle sharing system includes: a shared vehicle including: a passenger cabin including seats; antennas; and a module configured to, via the antennas, determine a present location of a key of the shared vehicle; and a server that is remote from the shared vehicle and that is configured to, in response to a request to end a period of use of the shared vehicle: determine whether the key is inside the passenger cabin; and determine whether to end the period of use of the shared vehicle and charge a payment account associated with a user for the period of use based on whether the key is inside of the passenger cabin.

### FIELD

The present disclosure relates to shared vehicles and more particularly to systems and methods for controlling use of shared vehicles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles are used to transport people and goods from place to place. Various different types of vehicles are available, such as trucks, multiple different types of utility vehicles, sedans, coupes, convertibles, etc.

Some vehicles may be owned and used by only one or more people. Other vehicles may be used for carsharing (also referred to as ridesharing). Multiple different types of carsharing are available, such as vehicle rentals, ride hailing, peer to peer car rental, commercial truck rentals, etc. In ride hailing, a driver of a vehicle verifies a rider's identity by asking the rider for his or her name and matching the given name to a name on a ride reservation. For other forms of carsharing, however, a driver or owner of the vehicle may not be present to verify identity.

### SUMMARY

In a feature, a vehicle sharing system includes: a shared vehicle including: a passenger cabin including seats; antennas; and a module configured to, via the antennas, determine a present location of a key of the shared vehicle; and a server that is remote from the shared vehicle and that is configured to, in response to a request to end a period of use of the shared vehicle: determine whether the key is inside the passenger cabin; and determine whether to end the period of use of the shared vehicle and charge a payment account associated with a user for the period of use based on whether the key is inside of the passenger cabin.

In further features: the key is a key fob of the shared vehicle; and the server is configured to end the period of use of the shared vehicle and charge the payment account associated with the user for the period of use in response to a determination that the key fob is inside of the passenger cabin.

In further features, the server is configured to not end the period of use of the shared vehicle and to not charge the payment account in response to a determination that the key fob is outside of the passenger cabin.

In further features: the shared vehicle includes door lock sensors of exterior doors, respectively, of the shared vehicle and configured to indicate whether the exterior doors, respectively, are locked or unlocked; and the server is configured to end the period of use of the shared vehicle and charge the payment account in response to a determination that both: the key fob is inside of the passenger cabin; and all of the exterior doors of the shared vehicle are locked.

In further features: the shared vehicle includes seat occupancy sensors of the seats, respectively, and configured to indicate whether at least a predetermined mass is present on the seats, respectively; and the server is configured to end the period of use of the shared vehicle and charge the payment account in response to a determination that both: the key fob is inside of the passenger cabin; and at least the predetermined mass is not present on any of the seats.

In further features: the server is configured to end the period of use of the shared vehicle and charge the payment account in response to a determination that both: the key fob is inside of the passenger cabin; and the shared vehicle is off.

In further features: the key is an electronic device; and the server is configured to end the period of use of the shared vehicle and charge the payment account associated with the user for the period of use in response to a determination that the electronic device is outside of the shared vehicle.

In further features, the server is configured to not end the period of use of the shared vehicle and to not charge the payment account in response to a determination that the electronic device is within the passenger cabin.

In further features, the electronic device is a smart phone.

In further features, the module is further configured to selectively unlock one or more exterior doors of the shared vehicle to the passenger cabin in response to a determination that the present location of the key transitioned from greater than a predetermined distance from the shared vehicle to less than a predetermined distance from the shared vehicle.

In a feature, a vehicle sharing method includes: via antennas of a shared vehicle, determining a present location of a key of the shared vehicle; by a server that is remote from the shared vehicle, in response to a request to end a period of use of the shared vehicle: determining whether the key is inside a passenger cabin of the shared vehicle, the passenger cabin of the shared vehicle including seats; and determining whether to end the period of use of the shared vehicle and charge a payment account associated with a user for the period of use based on whether the key is inside of the passenger cabin.

In further features: the key is a key fob of the shared vehicle; and determining whether to end the period of use of the shared vehicle and charge the payment account associated with the user includes determining whether to end the period of use of the shared vehicle and charge the payment account associated with the user for the period of use in response to a determination that the key fob is inside of the passenger cabin.

In further features, determining whether to end the period of use of the shared vehicle and charge the payment account associated with the user includes determining to not end the period of use of the shared vehicle and to not charge the payment account in response to a determination that the key fob is outside of the passenger cabin.

In further features the method further includes: by door lock sensors of exterior doors, respectively, of the shared vehicle, indicating whether the exterior doors, respectively, are locked or unlocked, where determining whether to end the period of use of the shared vehicle and charge the payment account associated with the user includes determining to end the period of use of the shared vehicle and charge the payment account in response to a determination that both: the key fob is inside of the passenger cabin; and all of the exterior doors of the shared vehicle are locked.

In further features the method further includes: by seat occupancy sensors of the seats, respectively, and indicating whether at least a predetermined mass is present on the seats, respectively, where determining whether to end the period of use of the shared vehicle and charge the payment account associated with the user includes determining to end the period of use of the shared vehicle and charge the payment account in response to a determination that both: the key fob is inside of the passenger cabin; and at least the predetermined mass is not present on any of the seats.

In further features, determining whether to end the period of use of the shared vehicle and charge the payment account associated with the user includes determining to end the period of use of the shared vehicle and charge the payment account in response to a determination that both: the key fob is inside of the passenger cabin; and the shared vehicle is off.

In further features: the key is an electronic device; and determining whether to end the period of use of the shared vehicle and charge the payment account associated with the user includes determining end the period of use of the shared vehicle and charge the payment account associated with the user for the period of use in response to a determination that the electronic device is outside of the shared vehicle.

In further features, determining whether to end the period of use of the shared vehicle and charge the payment account associated with the user includes determining to not end the period of use of the shared vehicle and to not charge the payment account in response to a determination that the electronic device is within the passenger cabin.

In further features, the electronic device is a smart phone.

In further features, the method further includes selectively unlocking one or more exterior doors of the shared vehicle to the passenger cabin in response to a determination that the present location of the key transitioned from greater than a predetermined distance from the shared vehicle to less than a predetermined distance from the shared vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example implementation of a vehicle rental system;

FIG. 2 is a functional block diagram of an example implementation of rental control system; and

FIGS. 3 and 4 are flowcharts depicting example methods of controlling rentals of vehicles

In the drawings, reference numbers may be reused to identify similar and/or identical elements.

### DETAILED DESCRIPTION

A user of the shared vehicle arranges for a period of use of the shared vehicle with a server using an electronic device, such as a cell phone, a tablet device, a smart watch, etc. The server provides a pickup location, date, and time to the electronic device. The server also provides a drop off location, date, and time for the vehicle to the electronic device.

A key fob used to start and drive a shared vehicle may be left in a glove box, console, or elsewhere within a passenger cabin of the vehicle with all of the doors of the vehicle locked in preparation for the use. In various implementations, the server may enable the electronic device to be used as the “key fob” (a digital key) and allow the vehicle to be started and driven when the electronic device is within the passenger cabin of the vehicle.

The electronic device can be used to authenticate the user and period of use with the server, and the vehicle may unlock one or more doors in response to a prompt from the server to begin the period of use. This allows the user to enter the passenger cabin, access the key fob if used, and drive or otherwise use the vehicle. A passive entry passive start (PEPS) module or passive entry (PE) module of the vehicle monitors a location of the key fob or electronic device, such as using a plurality of Bluetooth antennas of the vehicle.

When the use of the vehicle is complete, the user can leave the key fob within the passenger cabin when the vehicle is at the drop off location. The server may close a contract for the use of the vehicle with the user and take one or more other actions (e.g., perform an inspection). Closing of the contract may involve billing a payment method of the user of the electronic device for the period of use and any items identified during the inspection (e.g., key fob not in vehicle, low fuel, damage, etc.).

However, if the contract for the use of the vehicle is closed and the user does not leave the key fob within the vehicle, unauthorized use of the vehicle could pursue as the user may keep the key fob.

The present application involves the vehicle monitoring, at the end of use of the vehicle and before closing the contract for the use, (a) whether the doors of the vehicle are locked and (b) whether the key fob is in the vehicle or whether the electronic device is outside of the vehicle. The server only closes the contract (and takes the one or more other actions) when all of the doors of the vehicle are locked and the key fob is within the vehicle while no seats of the vehicle are occupied. In the example of use of the electronic device as the digital key, the server only closes the contract (and takes the one or more other actions) when all of the doors of the vehicle are locked and the electronic device is outside of the vehicle while no seats of the vehicle are occupied. This ensures that unauthorized use of the vehicle cannot occur.

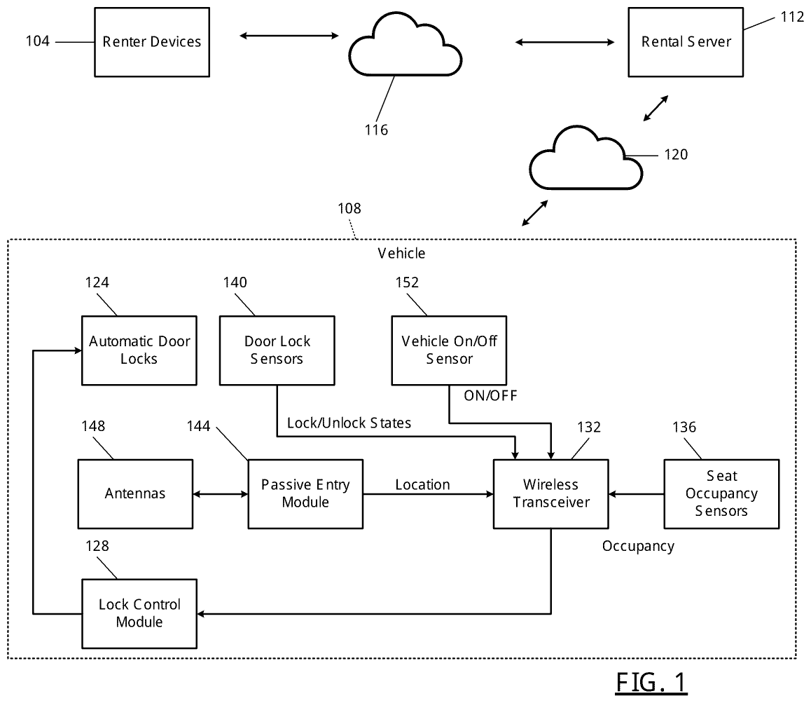

FIG. 1 includes a functional block diagram of an example implementation of a vehicle rental system. Vehicle renters can rent or otherwise share shared vehicles, such as vehicle 108, via renter computing devices 104. Examples of renter computing devices include cellular (smart) phones, tablet devices, laptop computers, and other types of computing devices.

One or more rental servers, such as rental server 112, manage vehicles that are available for rental, dates and times when the vehicles are available for rental, etc. The renter devices 104 communicate with the rental server(s) via a network 116, such as the Internet, to rent vehicles, such as the vehicle 108.

Via a renter device, a renter of a vehicle may reserve the vehicle 108 for rental for a rental period with the rental server 112. The rental period is a period of time and spans a predetermined date and time range (e.g., from date A at time B to date C at time D). The renter or an owner or manager of the vehicle may specify where pickup and/or drop off of the vehicle 108 is to occur by the renter. The rental server 112 may manage payment for the rental by the renter, payment for the rental to an owner or manager of a vehicle rented, and one or more other aspects of the rental.

One or more keys and/or key fobs for starting and using a rented vehicle could be left within a rental vehicle (e.g., within a glove box or console) with one or more doors of the vehicle unlocked for a renter. This, however, enables the possibility of someone other than the renter of the vehicle accessing and possibly driving the vehicle. The doors of the vehicle may therefore be locked, and the rental server 112 may trigger the vehicle to unlock one or more doors of the vehicle in response to communication with the renter device 104 of the renter.

The rental vehicles wirelessly communicate with the rental server 112 via a network 120, such as the Internet. While the example of the vehicle 108 will be described, each rental vehicle may function similarly and include the same components. Also, while the example of rental vehicles is provided, the present application is also applicable to other types of shared vehicles.

The vehicle 108 includes automatic door locks 124 that actuate and lock and unlock exterior doors, respectively, to a passenger cabin of the vehicle 108. A lock control module 128 may actuate the automatic door locks 124 and lock or unlock one or more of the doors in response to user input to one or more unlock/lock switches or buttons within the passenger cabin. The lock control module 128 may actuate the automatic door locks 124 and lock or unlock one or more of the doors in response to user input to one or more unlock/lock switches or buttons located on an exterior of the vehicle, such as when a key fob is within a predetermined distance of the exterior of the vehicle. The lock control module 128 may actuate the automatic door locks 124 and lock or unlock one or more of the doors in response to user input to one or more unlock/lock switches or buttons located on an exterior of the vehicle, such as when a key fob is within a predetermined distance of the exterior of the vehicle. The lock control module 128 may actuate the automatic door locks 124 and lock or unlock one or more of the doors in response to user input to the key fob. The lock control module 128 may actuate the automatic door locks 124 when one or more other conditions occur. In various implementations, manual door locks may also be manually actuated by users to lock and unlock doors, respectively.

According to the present application, as discussed further below, the lock control module 128 may actuate one or more of the automatic door locks 124 and unlock one or more of the doors, respectively, in response to authentication of a rental device associated with a rental of the vehicle 108 with the rental server 112. This allows the user to enter the passenger cabin, access the key fob (if used), and drive or otherwise use the vehicle 108 for a scheduled/reserved period of use (rental period).

The vehicle 108 includes a wireless transceiver 132 that communicates wirelessly with the rental server 112 via one or more antennas. The wireless transceiver 220 may be, for example, a satellite, WiFi, or cellular transceiver.

The vehicle 108 also includes seat occupancy sensors 136 of seats, respectively, within the passenger cabin of the vehicle 108. Each seat occupancy sensor indicates whether the respective seat is occupied or not. For example, a seat occupancy sensor may set a signal to a first state when a mass on the respective seat is greater than a predetermined mass. The seat occupancy sensor may set the signal to a second state when the mass on the respective seat is less than the predetermined mass. Each seat occupancy sensor may function the same. The seat occupancy sensors 136 collectively indicate whether and which seats of the vehicle 108 are occupied.

The vehicle 108 also includes door lock sensors 140. The door lock sensors 140 measure and indicate whether exterior doors, respectively, to the passenger cabin of the vehicle 108 are open. For example, a door lock sensor may set a signal to a first state when a respective door is locked. The door lock sensor may set the signal to a second state when the respective door is not locked. Each door lock sensor may function the same. The door lock sensors 140 collectively indicate whether and which doors of the vehicle 108 are locked.

The vehicle 108 also includes a passive entry module 144. The passive entry module 144 may include a passive entry passive start (PEPS) module in various implementations. The passive entry module 144 determines a present location of a key fob of the vehicle 108 wirelessly using antennas 148. For example, the antennas 148 may be disposed at or near respective corners (front left, front right, rear left, rear right) of the vehicle 108. One or more other ones of the antennas 148 may also be included and disposed at other locations of the vehicle 108. The passive entry module 144 may transmit signals wirelessly (e.g., using a Bluetooth communication protocol, such as in an Institute of Electrical and Electronics Engineers (IEEE) 802.15 standard) to the key fob via ones of the antennas 148. Based on signal strength indicators determined based on the signal strength (e.g., relative signal strength indicators (RSSI)) of the signals from the antennas, respectively, the passive entry module 144 determines a location of the key fob, such as using triangulation. The signal strength indicator from an antenna may increase as the key fob moves closer to that antenna and vice versa. The signal strength indicators from 3 or more antennas can be used to reliably determine a present location of a key fob relative to the vehicle 108, whether the key fob is outside of the vehicle 108, or whether the key fob is within the passenger cabin of the vehicle. When a renter device is used as a digital key, the passive entry module 144 may determine the location of the renter device relative to the vehicle 108 the same way.

The passive entry module 144 may take one or more actions based on the location of the key fob. For example, the passive entry module 144 may selectively unlock one or more doors of the vehicle 108 when the key fob transitions from greater than a predetermined distance from the vehicle 108 to less than a predetermined distance from the vehicle 108.

An ON/OFF sensor 152 indicates whether the vehicle 108 is on or off. The vehicle 108 may be turned on, for example, via actuation of one or more start/ignition buttons or switches when the vehicle 108 is off. The vehicle 108 may be turned off, for example, via actuation of the one or more start/ignition buttons or switches when the vehicle 108 is on. Additionally or alternatively, the passive entry module 144 (in the example of a PEPS module) may turn vehicle 108 on when the key fob transitions from greater than a predetermined distance from the vehicle 108 to less than a predetermined distance from the vehicle 108. In various implementations, the vehicle 108 may be turned on and off via user input to the key fob or renter device.

When the period of use of the vehicle 108 is complete, the renter may be expected to leave the key fob within the passenger cabin of the vehicle 108 and leave the vehicle at a drop off location. If the key fob is not in the vehicle 108 and the contract for the period of use of the vehicle 108 is closed out by the rental server 112, however, unauthorized use and access to the vehicle could occur.

The present application involves the passive entry module 144 providing the present location of the key fob or renter device to the rental server 112. The rental server 112 closes out the contract for the period of use of the vehicle 108 only when the key fob is within the passenger cabin of the vehicle 108 and the doors of the vehicle are locked, as indicated by the door lock sensors 140. In the example of use of the renter device 104, the rental server 112 closes out the contract for the period of use of the vehicle 108 only when the renter device 104 is outside of the passenger cabin of the vehicle 108 and the doors are locked. In various implementations, the rental server 112 may in addition to the above require that none of the seats be occupied, as indicated by the seat occupancy sensors 136, before closing out the contract for the period of use of the vehicle 108. This ensures that the renter is out of the vehicle 108 and the vehicle is secured before the contract for the period of use of the vehicle 108 is closed out.

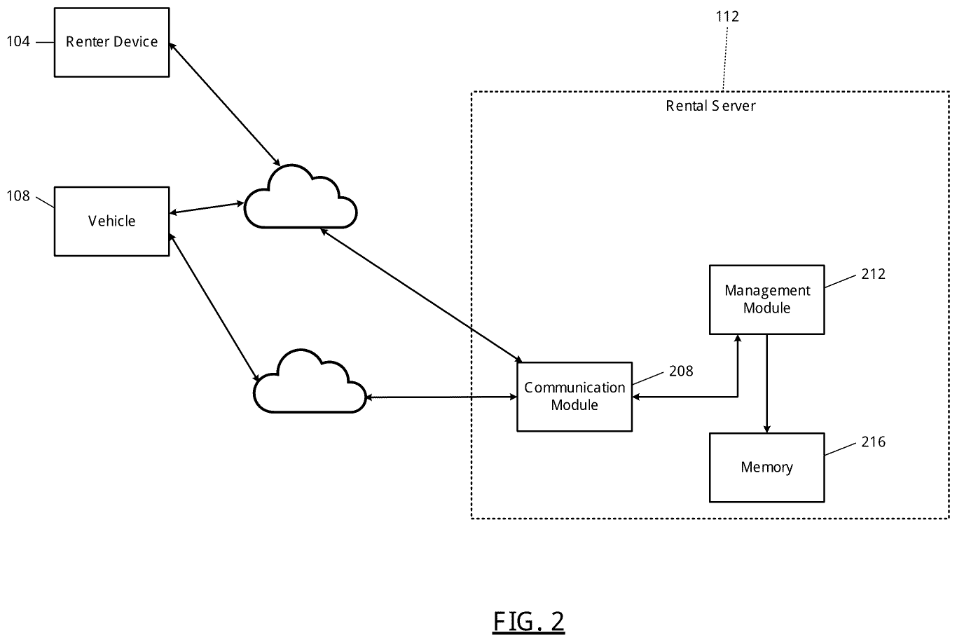

FIG. 2 is a functional block diagram of an example implementation of rental control system including the rental server 112.

The rental server 112 includes a communication module 208. The rental server 112 also includes a management module 212. The management module 212 manages opening and closing of use contracts with shared vehicle users, lists of available vehicles, locations of available vehicles, payment information (e.g., credit card numbers and expiration dates, bank routing and account number information) of users, and other information. The management module 212 stores various information in memory 216.

The communication module 208 communicates with renter devices and the rental vehicles via one or more networks. The management module 212 communicates with the rental devices and the rental vehicles via the communication module 208. The management module 212 may open a contract for the period of use of a vehicle in the memory 216 and store associated pickup location, drop off location, payment information, and other information when a period of use of a vehicle is requested and confirmed via a renter device.

When a request to end the period of use of the vehicle is received from the associated renter device, the management module 212 receives data from the vehicle, such as the location of the key fob of the vehicle or the location of the renter device used as a digital key/key fob, the lock states of the doors, respectively, the ON/OFF state of the vehicle, the occupancy statuses of the seats, respectively, and other information. The management module 212 determines whether the key fob is within the passenger cabin based on the information from the passive entry module 144. In the example of use of the renter device, the management module 212 determines whether the renter device is outside of the vehicle 108. The management module 212 also determines whether all of the doors of the vehicle 108 are locked. The management module 212 may also determine whether one or more of the seats of the vehicle are occupied based on the information from the occupancy sensors 136. The management module 212 may also determine whether the vehicle 108 is off. If all of the determinations are true, the management module 212 may close the contract for the period of use of the vehicle 108 and issue a charge to the payment information of the user stored in memory. The management module 212 may also take or initiate one or more other actions, such as conducting or scheduling an inspection, when all of the determinations are true.

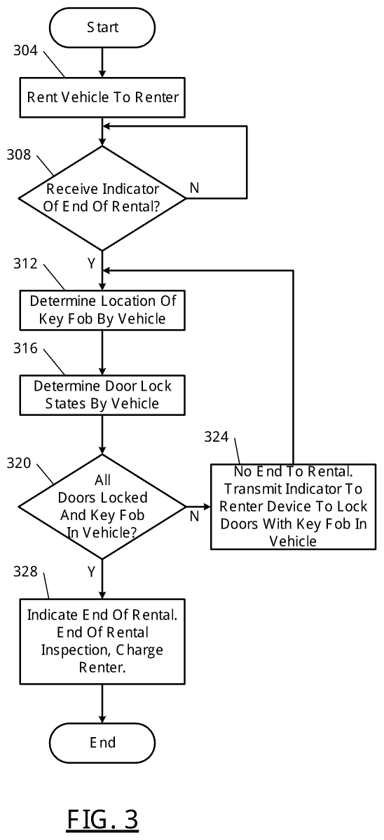

FIG. 3 is a flowchart depicting an example method of controlling a period of use of the vehicle 108. Control begins with 304 where the rental server 112 (e.g., the management module 212) rents the vehicle 108 to a user of a renter device for a period of use (a date and time range). The management module 212 begins allowing the user of the renter device to drive and use the vehicle. The management module 212 may unlock one or more doors of the vehicle 108.

At 308, the management module 212 may determine whether an indicator has been received from the renter device of the renter of the vehicle 108 to end the period of use of the vehicle 108. If 308 is true, control continues with 312. If 308 is false, control remains at 308 and the period of use of the vehicle 108 continues.

At 312, the passive entry module 144 determines the present location of the key fob of the vehicle 108 as described above. The management module 212 receives the present location of the key fob from the vehicle 108. At 316, the door lock sensors 140 determine the door lock states of the doors, respectively. The management module 212 receives the door lock states from the vehicle 108. The vehicle ON/OFF sensor 152 and the seat occupancy sensors 136 may also determine the vehicle ON/OFF state and whether the seats, respectively, of the vehicle are occupied. The management module 212 receives the vehicle ON/OFF state and the seat occupancy states from the vehicle 108.

At 320, the management module 212 determines whether all of the doors of the vehicle 108 are locked (based on the lock states) and whether the key fob is within the passenger cabin of the vehicle 108. The management module 212 may also determine whether all of the seats are not occupied (based on the seat occupancy states) and/or whether the vehicle 108 is off (based on the ON/OFF state) at 320. If 320 is false, control continues with 324. If 320 is true, control continues with 328.

At 324 (when at least one of the conditions of 320 is false), the management module 212 does not end the contract for the period of use for the vehicle 108 and (via the communication module 208) transmits an indicator to the renter device of the user to satisfy all of the conditions of 320. The renter device may display the indicator on a display of the renter device or audibly output the indicator via one or more speakers of the renter device. For example, the management module 212 may transmit an indicator to the renter device to lock all of the doors of the vehicle 108 if one or more of the doors are unlocked. Additionally or alternatively, the management module 212 may transmit an indicator to the renter device to put the key fob within the passenger cabin of the vehicle 108 (e.g., within the glove box or console) if the key fob is not within the passenger cabin of the vehicle. Additionally or alternatively, the management module 212 may transmit an indicator to the renter device to remove all items or persons from seats of the vehicle if one or more of the seats are occupied. Additionally or alternatively, the management module 212 may transmit an indicator to the renter device to turn the vehicle 108 off if the vehicle 108 is on. By not ending the contract, the cost for the period of use of the vehicle 108 may increase and responsibility for the vehicle 108 may remain with the renter. Control returns to 312.

At 328 (when all of the conditions of 320 are met concurrently), the management module 212 ends and closes the contract for the period of use of the vehicle 108 with the user of the renter device. The management module 212 may schedule or automatically (via sensors and/or cameras of the vehicle 108) perform a post-rental inspection of the vehicle 108. The management module 212 may transmit an indicator to the renter device that the conditions of 320 have been satisfied and that the contract for the period of use of the vehicle 108 will be closed. The management module 212 may also charge the payment account associated with the renter of the renter device for the period of use of the vehicle 108. In various implementations, the management module 212 may wait to charge the payment account until after the inspection is performed. The management module 212 may also credit a payment account associated with an owner or manager of the vehicle 108 for the period of use of the vehicle 108. Control then ends.

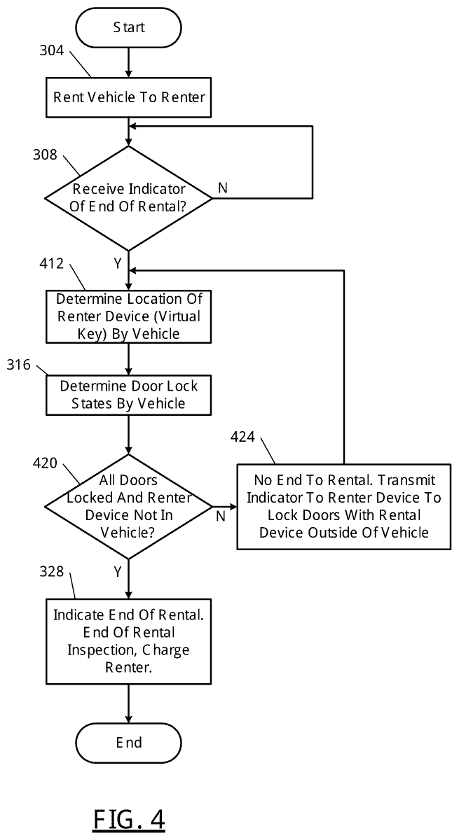

FIG. 4 is a flowchart depicting an example method of controlling a period of use of the vehicle 108. Portions of FIG. 4 are discussed above with respect to FIG. 3.

At 412, the management module 212 determines whether the location of the renter device (being used as a virtual key/key fob) relative to the vehicle 108. At 420, the management module 212 determines whether all of the doors of the vehicle 108 are locked (based on the lock states) and whether the renter device is outside of the vehicle 108 (i.e., not within the passenger cabin of the vehicle 108). The management module 212 may also determine whether all of the seats are not occupied (based on the seat occupancy states) and/or whether the vehicle 108 is off (based on the ON/OFF state) at 420. If 420 is false, control continues with 424. If 420 is true, control continues with 328.

At 424 (when at least one of the conditions of 420 is false), the management module 212 does not end the contract for the period of use for the vehicle 108 and (via the communication module 208) transmits an indicator to the renter device of the user to satisfy all of the conditions of 420. The renter device may display the indicator on a display of the renter device or audibly output the indicator via one or more speakers of the renter device. For example, the management module 212 may transmit an indicator to the renter device to lock all of the doors of the vehicle 108 if one or more of the doors are unlocked. Additionally or alternatively, the management module 212 may transmit an indicator to the renter device to move the renter device outside of the passenger cabin of the vehicle 108 if the renter device is within the passenger cabin of the vehicle. Additionally or alternatively, the management module 212 may transmit an indicator to the renter device to remove all items or persons from seats of the vehicle if one or more of the seats are occupied. Additionally or alternatively, the management module 212 may transmit an indicator to the renter device to turn the vehicle 108 off if the vehicle 108 is on. By not ending the contract, the cost for the period of use of the vehicle 108 may increase and responsibility for the vehicle 108 may remain with the renter. Control returns to 312.

In various implementations, the passive entry module 144 may not allow the doors of the vehicle to be locked with the key fob within the passenger cabin of the vehicle 108. The functionality discussed herein may therefore be used when the vehicle 108 is in a renter mode. Operation of the vehicle 108 in the renter mode allows the key fob to be left in the vehicle and the doors locked.

In a feature, a vehicle sharing system includes: a shared vehicle including: a passenger cabin including seats; antennas; and a module configured to, via the antennas, determine a present location of a key of the shared vehicle; and a server that is remote from the shared vehicle and that is configured to, in response to a request to end a period of use of the shared vehicle: determine whether the key is inside the passenger cabin; and determine whether to end the period of use of the shared vehicle and charge a payment account associated with a user for the period of use based on whether the key is inside of the passenger cabin.

In further features: the key is a key fob of the shared vehicle; and the server is configured to end the period of use of the shared vehicle and charge the payment account associated with the user for the period of use in response to a determination that the key fob is inside of the passenger cabin.

In further features, the server is configured to not end the period of use of the shared vehicle and to not charge the payment account in response to a determination that the key fob is outside of the passenger cabin.

In further features: the shared vehicle includes door lock sensors of exterior doors, respectively, of the shared vehicle and configured to indicate whether the exterior doors, respectively, are locked or unlocked; and the server is configured to end the period of use of the shared vehicle and charge the payment account in response to a determination that both: the key fob is inside of the passenger cabin; and all of the exterior doors of the shared vehicle are locked.

In further features: the shared vehicle includes seat occupancy sensors of the seats, respectively, and configured to indicate whether at least a predetermined mass is present on the seats, respectively; and the server is configured to end the period of use of the shared vehicle and charge the payment account in response to a determination that both: the key fob is inside of the passenger cabin; and at least the predetermined mass is not present on any of the seats.

In further features: the server is configured to end the period of use of the shared vehicle and charge the payment account in response to a determination that both: the key fob is inside of the passenger cabin; and the shared vehicle is off.

In further features: the key is an electronic device; and the server is configured to end the period of use of the shared vehicle and charge the payment account associated with the user for the period of use in response to a determination that the electronic device is outside of the shared vehicle.

In further features, the server is configured to not end the period of use of the shared vehicle and to not charge the payment account in response to a determination that the electronic device is within the passenger cabin.

In further features, the electronic device is a smart phone.

In further features, the module is further configured to selectively unlock one or more exterior doors of the shared vehicle to the passenger cabin in response to a determination that the present location of the key transitioned from greater than a predetermined distance from the shared vehicle to less than a predetermined distance from the shared vehicle.

In a feature, a vehicle sharing method includes: via antennas of a shared vehicle, determining a present location of a key of the shared vehicle; by a server that is remote from the shared vehicle, in response to a request to end a period of use of the shared vehicle: determining whether the key is inside a passenger cabin of the shared vehicle, the passenger cabin of the shared vehicle including seats; and determining whether to end the period of use of the shared vehicle and charge a payment account associated with a user for the period of use based on whether the key is inside of the passenger cabin.

In further features: the key is a key fob of the shared vehicle; and determining whether to end the period of use of the shared vehicle and charge the payment account associated with the user includes determining whether to end the period of use of the shared vehicle and charge the payment account associated with the user for the period of use in response to a determination that the key fob is inside of the passenger cabin.

In further features, determining whether to end the period of use of the shared vehicle and charge the payment account associated with the user includes determining to not end the period of use of the shared vehicle and to not charge the payment account in response to a determination that the key fob is outside of the passenger cabin.

In further features the method further includes: by door lock sensors of exterior doors, respectively, of the shared vehicle, indicating whether the exterior doors, respectively, are locked or unlocked, where determining whether to end the period of use of the shared vehicle and charge the payment account associated with the user includes determining to end the period of use of the shared vehicle and charge the payment account in response to a determination that both: the key fob is inside of the passenger cabin; and all of the exterior doors of the shared vehicle are locked.

In further features the method further includes: by seat occupancy sensors of the seats, respectively, and indicating whether at least a predetermined mass is present on the seats, respectively, where determining whether to end the period of use of the shared vehicle and charge the payment account associated with the user includes determining to end the period of use of the shared vehicle and charge the payment account in response to a determination that both: the key fob is inside of the passenger cabin; and at least the predetermined mass is not present on any of the seats.

In further features, determining whether to end the period of use of the shared vehicle and charge the payment account associated with the user includes determining to end the period of use of the shared vehicle and charge the payment account in response to a determination that both: the key fob is inside of the passenger cabin; and the shared vehicle is off.

In further features: the key is an electronic device; and determining whether to end the period of use of the shared vehicle and charge the payment account associated with the user includes determining end the period of use of the shared vehicle and charge the payment account associated with the user for the period of use in response to a determination that the electronic device is outside of the shared vehicle.

In further features, determining whether to end the period of use of the shared vehicle and charge the payment account associated with the user includes determining to not end the period of use of the shared vehicle and to not charge the payment account in response to a determination that the electronic device is within the passenger cabin.

In further features, the electronic device is a smart phone.

In further features, the method further includes selectively unlocking one or more exterior doors of the shared vehicle to the passenger cabin in response to a determination that the present location of the key transitioned from greater than a predetermined distance from the shared vehicle to less than a predetermined distance from the shared vehicle.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle sharing system comprising:
a shared vehicle including:
a passenger cabin including seats;
antennas; and
a module configured to, via the antennas, determine a present location of a key of the shared vehicle; and
a server that is remote from the shared vehicle and that is configured to, in response to a request to end a period of use of the shared vehicle:
determine whether the key is inside the passenger cabin; and
determine whether to end the period of use of the shared vehicle and charge a payment account associated with a user for the period of use based on whether the key is inside of the passenger cabin.

2. The vehicle sharing system of claim 1 wherein:
the key is a key fob of the shared vehicle; and
the server is configured to end the period of use of the shared vehicle and charge the payment account associated with the user for the period of use in response to a determination that the key fob is inside of the passenger cabin.

3. The vehicle sharing system of claim 2 wherein the server is configured to not end the period of use of the shared vehicle and to not charge the payment account in response to a determination that the key fob is outside of the passenger cabin.

4. The vehicle sharing system of claim 2 wherein:
the shared vehicle includes door lock sensors of exterior doors, respectively, of the shared vehicle and configured to indicate whether the exterior doors, respectively, are locked or unlocked; and
the server is configured to end the period of use of the shared vehicle and charge the payment account in response to a determination that both:
the key fob is inside of the passenger cabin; and
all of the exterior doors of the shared vehicle are locked.

5. The vehicle sharing system of claim 2 wherein:
the shared vehicle includes seat occupancy sensors of the seats, respectively, and configured to indicate whether at least a predetermined mass is present on the seats, respectively; and
the server is configured to end the period of use of the shared vehicle and charge the payment account in response to a determination that both:
the key fob is inside of the passenger cabin; and
at least the predetermined mass is not present on any of the seats.

6. The vehicle sharing system of claim 2 wherein:
the server is configured to end the period of use of the shared vehicle and charge the payment account in response to a determination that both:
the key fob is inside of the passenger cabin; and
the shared vehicle is off.

7. The vehicle sharing system of claim 1 wherein:
the key is an electronic device; and
the server is configured to end the period of use of the shared vehicle and charge the payment account associated with the user for the period of use in response to a determination that the electronic device is outside of the shared vehicle.

8. The vehicle sharing system of claim 7 wherein the server is configured to not end the period of use of the shared vehicle and to not charge the payment account in response to a determination that the electronic device is within the passenger cabin.

9. The vehicle sharing system of claim 7 wherein the electronic device is a smart phone.

10. The vehicle sharing system of claim 1 wherein the module is further configured to selectively unlock one or more exterior doors of the shared vehicle to the passenger cabin in response to a determination that the present location of the key transitioned from greater than a predetermined distance from the shared vehicle to less than a predetermined distance from the shared vehicle.

11. A vehicle sharing method comprising:
via antennas of a shared vehicle, determining a present location of a key of the shared vehicle;
by a server that is remote from the shared vehicle, in response to a request to end a period of use of the shared vehicle:
determining whether the key is inside a passenger cabin of the shared vehicle, the passenger cabin of the shared vehicle including seats; and
determining whether to end the period of use of the shared vehicle and charge a payment account associated with a user for the period of use based on whether the key is inside of the passenger cabin.

12. The vehicle sharing method of claim 11 wherein:
the key is a key fob of the shared vehicle; and
determining whether to end the period of use of the shared vehicle and charge the payment account associated with the user includes determining whether to end the period of use of the shared vehicle and charge the payment account associated with the user for the period of use in response to a determination that the key fob is inside of the passenger cabin.

13. The vehicle sharing method of claim 12 wherein determining whether to end the period of use of the shared vehicle and charge the payment account associated with the user includes determining to not end the period of use of the shared vehicle and to not charge the payment account in response to a determination that the key fob is outside of the passenger cabin.

14. The vehicle sharing method of claim 12 further comprising:
by door lock sensors of exterior doors, respectively, of the shared vehicle, indicating whether the exterior doors, respectively, are locked or unlocked,
wherein determining whether to end the period of use of the shared vehicle and charge the payment account associated with the user includes determining to end the period of use of the shared vehicle and charge the payment account in response to a determination that both:
the key fob is inside of the passenger cabin; and
all of the exterior doors of the shared vehicle are locked.

15. The vehicle sharing method of claim 12 further comprising:
by seat occupancy sensors of the seats, respectively, and indicating whether at least a predetermined mass is present on the seats, respectively,
wherein determining whether to end the period of use of the shared vehicle and charge the payment account associated with the user includes determining to end the period of use of the shared vehicle and charge the payment account in response to a determination that both:
the key fob is inside of the passenger cabin; and
at least the predetermined mass is not present on any of the seats.

16. The vehicle sharing method of claim 12 wherein determining whether to end the period of use of the shared vehicle and charge the payment account associated with the user includes determining to end the period of use of the shared vehicle and charge the payment account in response to a determination that both:
the key fob is inside of the passenger cabin; and
the shared vehicle is off.

17. The vehicle sharing method of claim 11 wherein:
the key is an electronic device; and
determining whether to end the period of use of the shared vehicle and charge the payment account associated with the user includes determining end the period of use of the shared vehicle and charge the payment account associated with the user for the period of use in response to a determination that the electronic device is outside of the shared vehicle.

18. The vehicle sharing method of claim 17 wherein determining whether to end the period of use of the shared vehicle and charge the payment account associated with the user includes determining to not end the period of use of the shared vehicle and to not charge the payment account in response to a determination that the electronic device is within the passenger cabin.

19. The vehicle sharing method of claim 17 wherein the electronic device is a smart phone.

20. The vehicle sharing method of claim 11 further comprising selectively unlocking one or more exterior doors of the shared vehicle to the passenger cabin in response to a determination that the present location of the key transitioned from greater than a predetermined distance from the shared vehicle to less than a predetermined distance from the shared vehicle.
